(19) United States
(12) Patent Application Publication
(10) Pub. No.: US 2015/0295783 A1
(43) Pub. Date: Oct. 15, 2015

(54) METHOD FOR REAL-TIME MULTIMEDIA INTERFACE MANAGEMENT SENSOR DATA

(71) Applicant: SCREENOVATE TECHNOLOGIES LTD., Ra'anana (IL)

(72) Inventors: Joshua GLAZER, R'annana (IL); Matan SHAPIRA, Tel Aviv (IL)

(21) Appl. No.: 14/683,214

(22) Filed: Apr. 10, 2015

Related U.S. Application Data
(60) Provisional application No. 61/977,698, filed on Apr. 10, 2014.

(51) Int. Cl. H04L 12/24; G06F 3/0488; H04L 29/08; H04L 29/06; H04W 4/00

(52) U.S. Cl. CPC H04L 41/22; H04L 65/60; H04W 4/008; H04L 67/10; G06F 3/0488

(57) ABSTRACT

The present invention provides a method for real-time multimedia interface management of receiver module associated or integrated with an external display. The receiver device having processor and communication module for supporting streaming multimedia applications. The method comprising the steps of: reverse mirroring of activated multimedia applications from the receiver module to a touch enabled device through direct local wireless communication network; and concurrently or non-concurrently, conveying input data from the touch enabled device in real-time to the receiver device through direct local wireless communication network and conveying sensor-related data between the receiver module touch enabled device through direct local wireless communication network, said sensor-related data applied on the touch enabled device or the receiver module according to pre-defined rules and in a way that remotely operates as if the sensor-related data originates in the touch enabled device itself or in the receiver module;

### TECHNICAL FIELD

The present invention relates to the field of multimedia interface management, and more particularly, to mirroring multimedia interface and application between two different computerized communication devices.

### SUMMARY OF INVENTION

The present invention provides a method for real-time multimedia interface management of receiver module associated or integrated with an external display. The receiver device having processor and communication module for supporting streaming multimedia applications. The method comprising the steps of: reverse mirroring of activated multimedia applications from the receiver module to a touch enabled device through direct local wireless communication network; and concurrently or non-concurrently and conveying input data from the touch enabled device in real-time to the receiver device through direct local wireless communication network.

According to some embodiments of the present invention, is provided a method for real-time multimedia interface management of receiver module associated or integrated with an external display. The receiver device having processor and communication module for supporting streaming multimedia applications. The method comprising the steps of: receiving and identifying, in real time, information parameters of streamed multimedia on the receiver device, reverse streaming of video application interface from the receiver module to a touch enabled device, conveying input data from the touch enabled device in real-time to the receiver device through direct local wireless communication network and reverse streaming of partial video/audio data from the receiver module to the touch enabled device based on the received input data and pre-defined rules or user control.

The present invention provides a method for real-time multimedia interface management of receiver module associated or integrated with an external display, the receiver device having processor and communication module for supporting streaming multimedia applications. The method comprising the steps of: reverse mirroring of activated multimedia applications from the receiver module to a touch enabled device through direct local wireless communication network; and concurrently or non-concurrently, conveying input data from the touch enabled device in real-time to the receiver device through direct local wireless communication network, wherein the input data is related to the activation of mirrored multimedia applications and conveying sensor-related data between the receiver module touch enabled device through direct local wireless communication network, said sensor-related data applied on the touch enabled device or the receiver module according to pre-defined rules and in a way that remotely operates as if the sensor-related data originates in the touch enabled device itself or in the receiver module.

The reverse mirroring and conveying input data is performed by at least one processor.

According to some embodiments of the present invention, the input data include sensor information: all input being received from sensors including at least one of: Touch screen input, Gyroscope movement or Accelerometer input, wherein the receiver process the transmitted input data as if the actions detected by the sensors were performed on the receiver itself.

According to some embodiments of the present invention further comprising the steps of: conveying sensor-related data from the receiver module through direct local wireless communication network and applying sensor-related data on the touch enabled device according to pre-defined rules and in a way that remotely operates as if the data originates in the touch enabled device itself.

According to some embodiments of the present invention wherein input data include peripheral information: all input generated by external devices connected to the touch enabled device are transmitted to the receiver and processed by receiver, as if these devices were actually connected to the receiver module.

According to some embodiments of the present invention further comprising the steps of: receiving and identifying, in real time, information parameters of relating a use case of the streamed multimedia on the receiver device,

wherein the reverse mirroring streaming include only partial video/audio data or additional data from the receiver module to the touch enabled device in accordance with the received information parameters and pre-defined rules which define the type, format, timing or context of partial video/audio data to be streamed.

According to some embodiments of the present invention the information parameters indicate of user input.

According to some embodiments of the present invention the information parameters indicate of sensor data of the touch enabled device.

According to some embodiments of the present invention the input data includes partial or additional data includes at least one of: video interface, audio data, subtitle.

According to some embodiments of the present invention the information parameters relate uses case of watching video, wherein the video is displayed only at the external display and the reverse mirroring include only control interface to be displayed on the mobile device.

According to some embodiments of the present invention the information parameters indicate of user connecting a head set, related uses case of watching video, wherein the video is displayed only at the external display and the reverse mirroring include audio stream.

According to some embodiments of the present invention the streaming quality of control interface is degraded. by degrading the frame rate of the UI elements motion.

According to some embodiments of the present invention the information parameters relate uses case of games playing session the pre-defined rule determines to decrease the video parameters, while sending all sensor information to the dongle.

According to some embodiments of the present invention the the information parameters relates to use case of Static applications, identifying when the user view mostly static information, the pre-defined rule determines to decrease the frame rate significantly, while increasing the bit rate.

According to some embodiments of the present invention the method further comprising the step of receiving an indication of activation of nearby receiver module before starting the reverse mirroring streaming process.

According to some embodiments of the present invention the method further comprising the step of identifying the current status of multimedia activation and wherein the reverse mirroring include streaming the multimedia activated content.

According to some embodiments of the present invention, is provided a system including at least one processor for real-time multimedia interface management of receiver module associated or integrated with an external display, said receiver device having processor and communication module for supporting streaming multimedia applications. The system comprised of: a receiver module including Reverse mirroring module for reverse mirroring of activated multimedia applications from the receiver module to a touch enabled device through direct local wireless communication network, a touch enabled device which and concurrently or non-concurrently convey input data in real-time to the receiver device through direct local wireless communication network and an interaction module for conveying sensor-related data between the receiver module touch enabled device through direct local wireless communication network, said sensor-related data applied on the touch enabled device or the receiver module according to pre-defined rules and in a way that remotely operates as if the sensor-related data originates in the touch enabled device itself or in the receiver module;

According to some embodiments of the present invention the input data include sensor information: all input being received from sensors including at least one of: Touch screen input, Gyroscope movement or Accelerometer input, wherein the receive process the transmitted input data as if the actions detected by the sensors were performed on the receiver itself.

According to some embodiments of the present invention the interface module apply the following: Conveying sensor-related data from the receiver module through direct local wireless communication network, applying sensor-related data on the touch enabled device according to pre-defined rules and in a way that remotely operates as if the data originates in the touch enabled device itself.

According to some embodiments of the present invention the input data include peripheral information: all input generated by external devices connected to the touch enabled device are transmitted to the receiver and processed by receiver, as if these devices were actually connected to the receiver module.

These, additional, and/or other aspects and/or advantages of the present invention are: set forth in the detailed description which follows; possibly inferable from the detailed description; and/or learnable by practice of the present invention.

### BRIEF DESCRIPTION OF DRAWINGS

FIG. 1 is a block diagram of the system components and modules, according to some embodiments of the invention;

FIG. 2 shows the display screen on the touch enabled device and on an external screen, according to some embodiments of the invention;

FIG. 3 is a flowchart illustrating mirroring module activities providing full mirroring of the receiver device, according to some embodiments of the invention; and

FIG. 4 is a flowchart illustrating mirroring module activities providing full mirroring of the receiver device, according to some embodiments of the invention.

FIG. 5 is a flowchart illustrating interaction module activities providing full mirroring of the receiver device, according to some embodiments of the invention; and

FIG. 6 is a flowchart illustrating interaction module activities providing full mirroring of the receiver device, according to some embodiments of the invention.

### MODES FOR CARRYING OUT THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The term “touch enabled device” as used herein in this application, is defined as a mobile device having a touch screen with capability of running applications as well as streaming multimedia data to a screen that is external to the computerized mobile device (e.g. a mobile phone or a tablet device).

The term “receiver module” as used herein in this application, is defined as a processing communication module embedded in a dongle device or integrated in external screen such as TV or monitor device which support managing activating and streaming multimedia application.

The term “multimedia application” as used herein in this application, is defined as application which generate images, video or sound objects, such as video application, gaming application, chatting application or advertising.

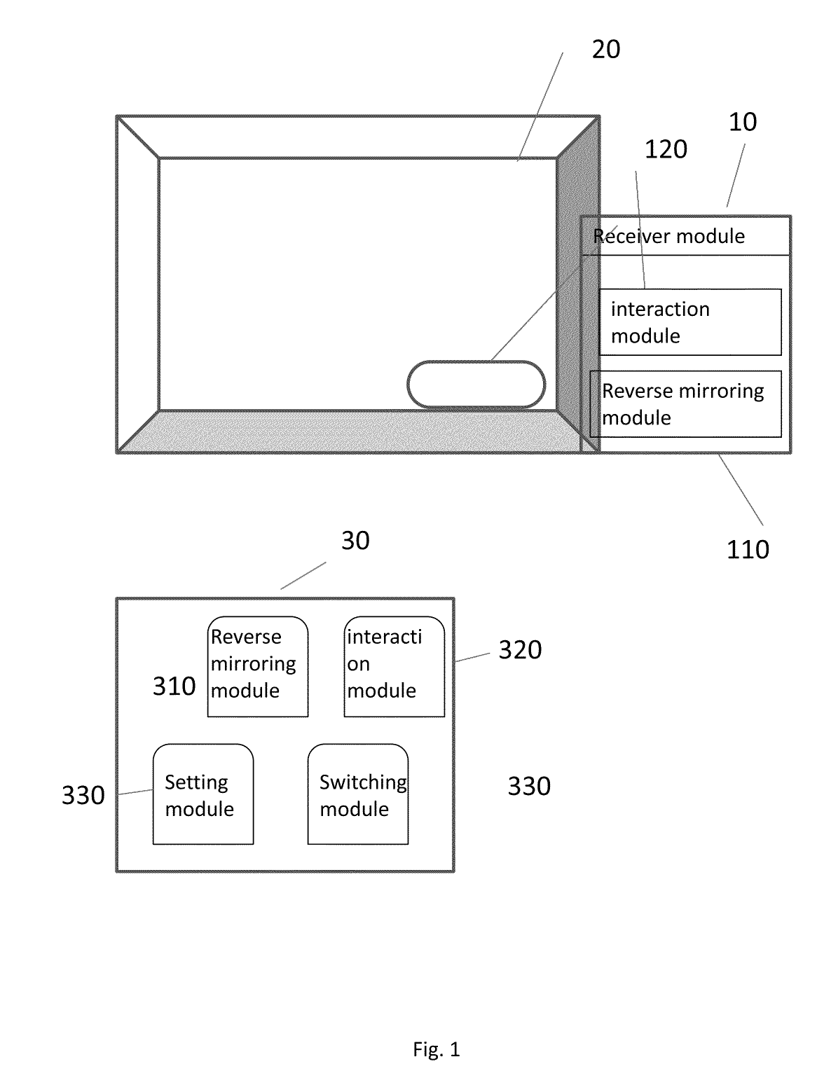

FIG. 1 is a block diagram of the system components and modules, according to some embodiments of the invention. The system of the present invention includes a receiver module 10 which embedded in a dongle device or integrated in external screen such as TV or monitor device. The receiver module 10 interacts with a touch enabled device, which is designated to function as interface device for the receiver module for managing multimedia applications. This interfacing interaction is enabled by mirroring modules 110, 310 for streaming back the interface of the receiver module and the running application to the touch enabled device, these modules can be implemented, partly at the receiver module or the touch enabled device or partly at the touch enabled device. Interaction modules 120, 130 support conveying input data and sensor data from the touch enabled device, to the receiver module to enable full interface functionality. These interaction modules can be implemented, partly at the receiver module or the touch enabled device or partly at the touch enabled device.

According to some embodiments of the present invention the receiver module and touch enabled device are communicating through direct local wireless network such as WIFI direct, or Bluetooth. Optionally the devices are connected though global wireless or wired network using cellular network or the Internet.

According to some embodiments of the present invention it is suggest to provide setting module 330 at the touch enabled device, enabling to convey and defined communication setting at the receiver by the touch enabled device.

According to some embodiments of the present invention it is suggested to provide switching module 340 at the touch enabled device, to enable dynamic switching of interface and activation control between at least one touch enable device and receiver module.

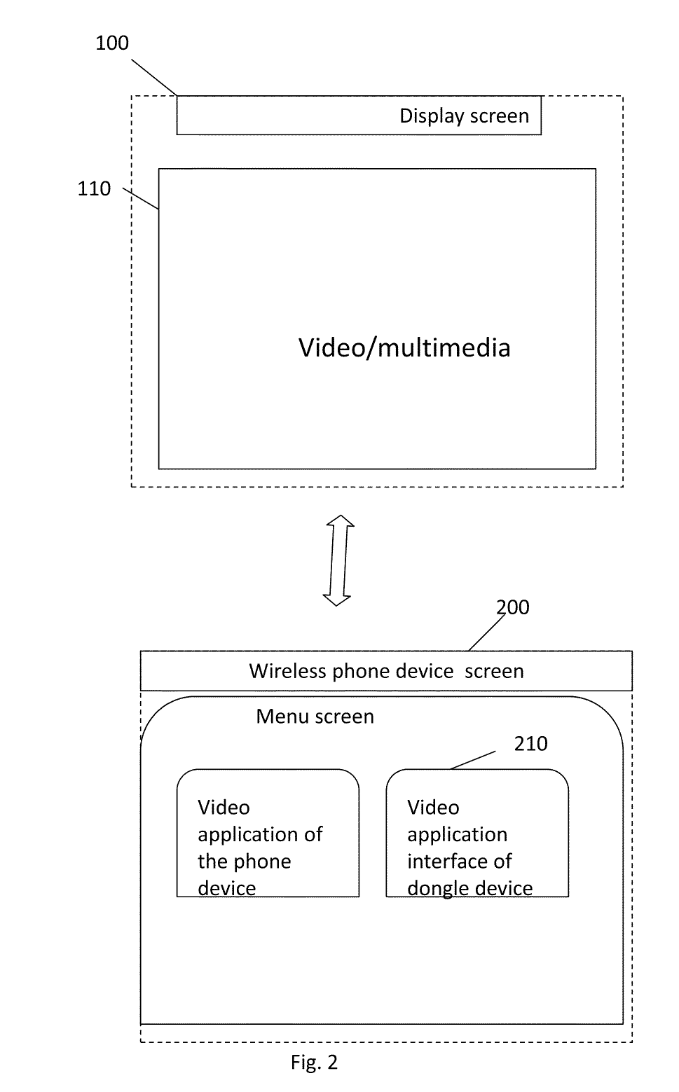

FIG. 2 shows an example of display screens on the touch enabled device and on an external screen, according to some embodiments of the invention. In this examples is displayed menu screen on the mobile device such as smart phone, including, displaying Video application interface of dongle device, while on the target screen is displayed full video

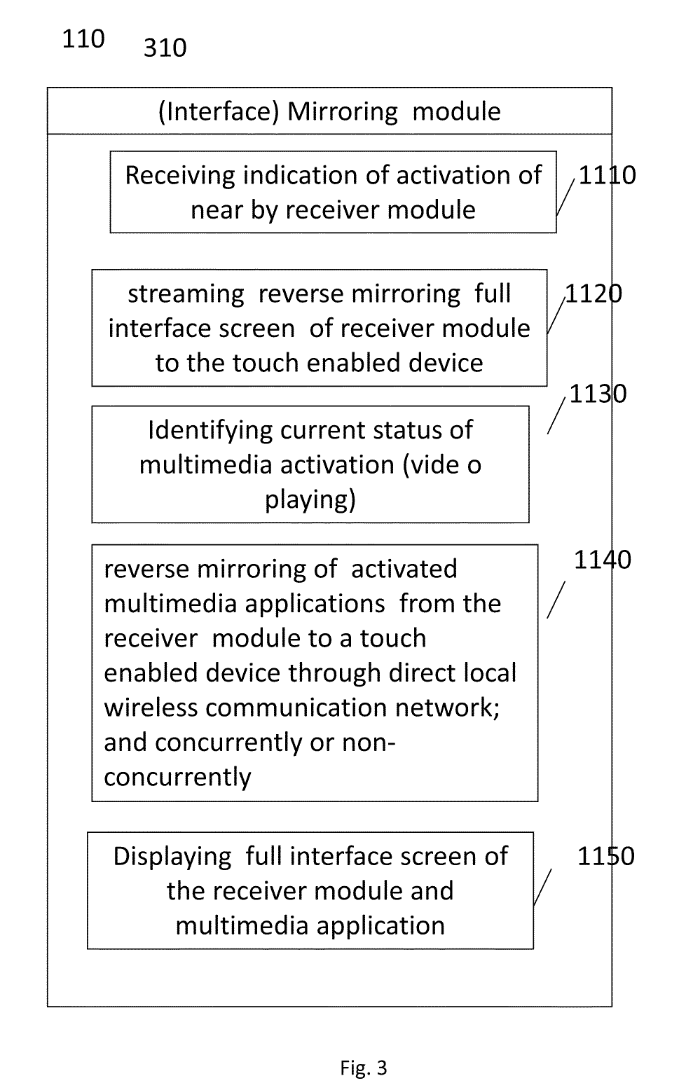

FIG. 3 is a flowchart illustrating mirroring module activities providing full mirroring of the receiver device, according to some embodiments of the invention. The mirroring module functioning as a full interface, implements at least one of the following steps: Receiving indication of activation of nearby receiver module of touch enabled device (step 1110), streaming reverse mirroring of full interface screen of receiver module to the touch enabled device (step 1120), identifying current status of multimedia activation (e.g. video starts playing) (step 1130), reverse mirroring of activated multimedia applications from the receiver module to a touch enabled device through direct local wireless communication network, concurrently or non-concurrently (step 1140) and/or displaying full interface screen of the receiver module and multimedia application (step 1150) including full movie video stream or gaming video. The reverse mirroring may be implemented by WIFI direct protocols or optionally using global communication network such as TCP/IP.

The full mirroring stream from the receiver to touch enabled device include: audio stream: audio being played on the receiver is being transmitted to the touch enabled device, and played on it.

Video stream: Entire video content being displayed on the receiver device internal display is being transmitted to the touch enabled device, and displayed on it.

The full mirroring stream from touch enabled device to the receiver may further include:

Sensor information: all input being received from sensors (Touch screen input, Gyroscope movement, Accelerometer input) is being transmitted to the receiver, which process the input as if the actions detected by the sensors were performed on the receiver itself.

Peripheral information: all input generated by external devices such as printers, speakers etc. connected to the touch enabled device (e.g. via HCl Host Controller Interface) are transmitted to the receiver and processed by receiver, as if these devices were actually connected to that receiver.

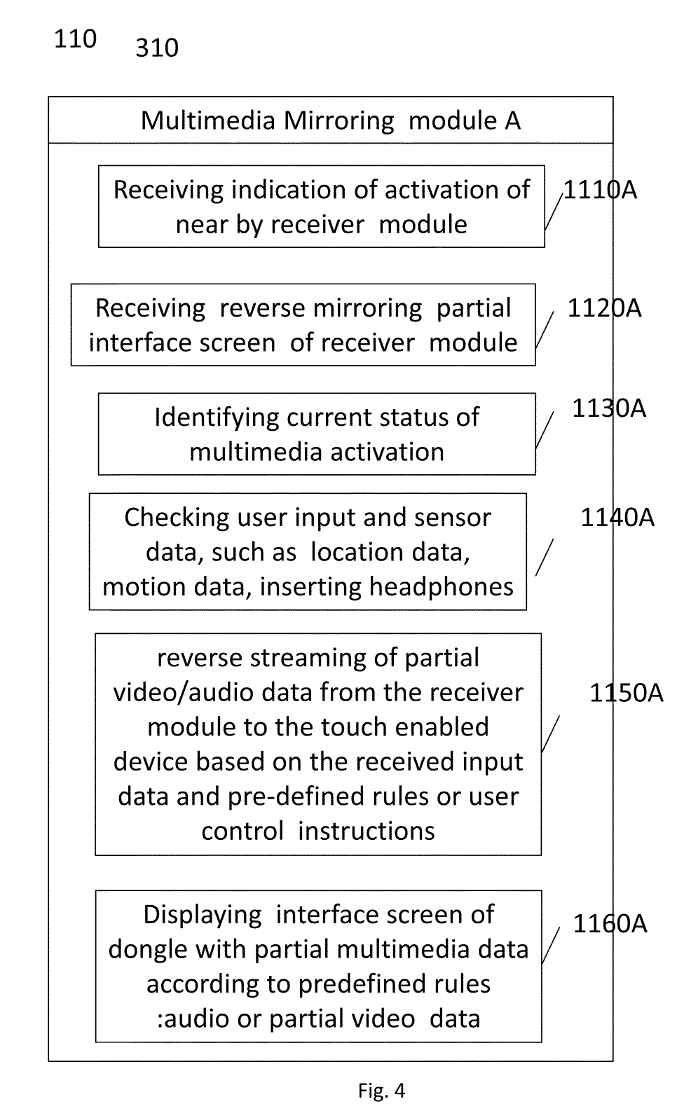

FIG. 4 is a flowchart illustrating mirroring module activities providing partial or additional mirroring of the receiver device, according to some embodiments of the invention. The mirroring module functioning as partial dynamic interface, implements at least one of the following steps: receiving indication of activation of nearby receiver module (step 1110A), receiving reverse mirroring of partial interface screen of receiver module (step 1120A) or additional information or content to be displayed, identifying current status of multimedia activation (step 1130A), checking user input and measured sensor data of the touch enabled device, such as location data, motion data or inserting headphones (step 1140A), reverse streaming of partial video/audio data from the receiver module to the touch enabled device based on the received input data and pre-defined rules or user control instructions (step 1150A) and/or displaying interface screen of the receiver module with partial multimedia data according to predefined rules 1160. The predefined rules may define the type, format, timing or context of partial video/audio data to be streamed in accordance with the received input data. The predefined rules may relate to different use case, scenarios when using multimedia application such video and gaming application. One scenario may define to include only control functionality (e.g. pause, play) of a video application, while the video itself is displayed only on the external screen. In the same scenario it may be defined to check the location of the touch enabled device using GPS sensor embedded within the touch enabled device, incase identifying the user walked away from the external screen, based on the predefined rules it is instructed to include the video itself to be displayed on the touch enabled device, enabling the user keep viewing the streamed video when leaving the area where the external screen is not visible. According to a second scenario, it is defined to identify connection of headphone to the touch enabled device, in such case predefined rules instruct the audio stream of a video currently running on receiver to be conveyed to the touch display device. According to a third scenario, the touch enabled device is enabled to display movie subtitles, not appearing at the external display. According to forth scenario, when streaming video application, the stream video may be mirrored in lower resolution, using lower bandwidth.

Basic Scenarios Uses Cases

1. Sending only audio from the dongle to the device—this can be used when watching a movie on the dongle, while listening to it's audio track using headphones connected to the hand held device.

2. Sending the screen of a video player application, while dropping the video part of the display (i.e. showing a placeholder image where the movie would have been), thus transmitting only the relevant information for control needs.

3. Decreasing video stream parameters (Decreasing bitrate, frame rate or resolution) of the receiver's display, thus transferring a complete look & feel of the receiver screen, while requiring less network bandwidth.

Implementations Examples of Use Cases:

1. Identifying new connection to headset (or earphones)—upon identification a pre-defined rule determines only audio is transmitted back to the device.

2. In case if Identifying Video playback session the pre-defined rule determine audio is not transmitted at all and video is removed from the screen and preforming degradation of streaming quality of control interface as the user experience will not be affected much by degrading the frame rate of the UI elements motion.

3. Incase of games playing session the pre-defined rule determines to decrease the video parameters, while sending all sensor information to the dongle.

4. Incase of Static applications, according to the predefined rules identifying the user shows a mostly static information (e.g. showing a picture slideshow), decreasing the frame rate significantly (while increasing the bit rate) to provide a crisp picture, while taking the consideration the fact that there is no need for smooth movement at the time.

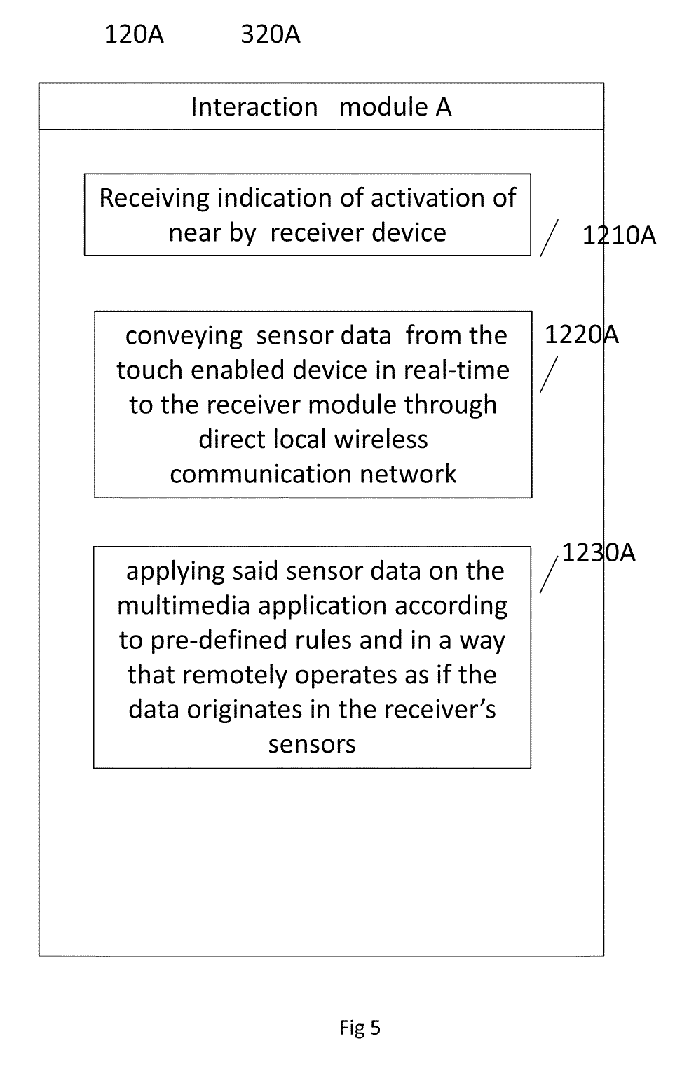

FIG. 5 is a flowchart illustrating interaction module activities providing input data and sensor data to the receiver device, according to some embodiments of the invention. This module implement at least one of the following steps: Receiving indication of activation of nearby receiver device (step 1210 A), conveying sensor data from the touch enabled device in real-time to the receiver module through direct local wireless communication network (step 1220 A), applying said sensor data on the multimedia application according to pre-defined rules and in a way that remotely operates as if the data originates in the receiver's sensors (step 1230 A). The sensor data may include accelerator measurements, gyro measurements, Camera, touch input or finger print.

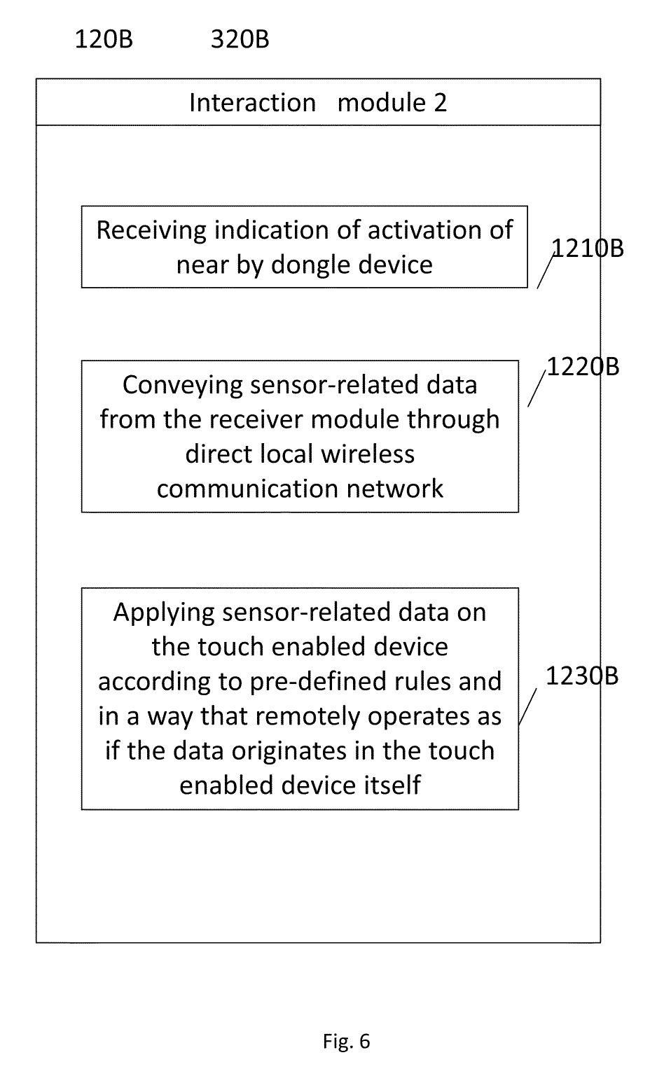

FIG. 6 is a flowchart illustrating interaction module activities providing input data and sensor data to the receiver device, according to some embodiments of the invention. This module implement at least one of the following steps: Receiving indication of activation of nearby receiver device (step 1210 B), conveying sensor-related data from the receiver module through direct local wireless communication network (step 1220 B) and/or applying sensor-related data on the touch enabled device according to pre-defined rules and in a way that remotely operates as if the data originates in the touch enabled device itself (step 1230 B).

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may wherever suitable operate on signals representative of physical objects or substances.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of a computer or computing system, or processor or similar electronic computing device, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

It is appreciated that software components of the present invention including programs and data may, if desired, be implemented in ROM (read only memory) form including CD-ROMs, EPROMs and EEPROMs, or may be stored in any other suitable typically non-transitory computer-readable medium such as but not limited to disks of various kinds, cards of various kinds and RAMs. Components described herein as software may, alternatively, be implemented wholly or partly in hardware, if desired, using conventional techniques. Conversely, components described herein as hardware may, alternatively, be implemented wholly or partly in software, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including a processor and a cooperating input device and/or output device and operative to perform in software any steps shown and described herein; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any step described herein may be computer-implemented. The invention shown and described herein may include (a) using a computerized method to identify a solution to any of the problems or for any of the objectives described herein, the solution optionally include at least one of a decision, an action, a product, a service or any other information described herein that impacts, in a positive manner, a problem or objectives described herein; and (b) outputting the solution.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Features of the present invention which are described in the context of separate embodiments may also be provided in combination in a single embodiment.

For example, a system embodiment is intended to include a corresponding process embodiment. Also, each system embodiment is intended to include a server-centered “view” or client centered “view”, or “view” from any other node of the system, of the entire functionality of the system, computer-readable medium, apparatus, including only those functionalities performed at that server or client or node.

What is claimed is:

1. A method for real-time multimedia interface management of receiver module associated or integrated with an external display, said receiver device having processor and communication module for supporting streaming multimedia applications, said method comprising the steps of:
reverse mirroring of activated multimedia applications from the receiver module to a touch enabled device through direct local wireless communication network;
and concurrently or non-concurrently
conveying input data from the touch enabled device in real-time to the receiver device through direct local wireless communication network, wherein the input data is related to the activation of mirrored multimedia applications; and
conveying sensor-related data between the receiver module touch enabled device through direct local wireless communication network, said sensor-related data applied on the touch enabled device or the receiver module according to pre-defined rules and in a way that remotely operates as if the sensor-related data originates in the touch enabled device itself or in the receiver module;
wherein the reverse mirroring and conveying input data is performed by at least one processor.

2. The method of claim 1 wherein the input data include sensor information: all input being received from sensors including at least one of: Touch screen input, Gyroscope movement or Accelerometer input, wherein the receiver process the transmitted input data as if the actions detected by the sensors were performed on the receiver itself.

3. The method of claim 1 further comprising the steps of.
conveying sensor-related data from the receiver module through direct local wireless communication network;
applying sensor-related data on the touch enabled device according to pre-defined rules and in a way that remotely operates as if the data originates in the touch enabled device itself.

4. The method of claim 1 wherein input data include peripheral information: all input generated by external devices connected to the touch enabled device are transmitted to the receiver and processed by receiver, as if these devices were actually connected to the receiver module.

5. A method of claim 1 further comprising the steps of:
receiving and identifying, in real time, information parameters of relating a use case of the streamed multimedia on the receiver device;
wherein the reverse mirroring streaming include only partial video/audio data or additional data from the receiver module to the touch enabled device in accordance with the received information parameters and pre-defined rules which define the type, format, timing or context of partial video/audio data to be streamed.

6. The method of claim 2 wherein information parameters indicate of user input.

7. The method of claim 2 wherein information parameters indicate of sensor data of the touch enabled device.

8. The method of claim 2 wherein the input data includes partial or additional data includes at least one of: video interface, audio data, subtitle.

9. The method of claim 2 wherein the information parameters relate uses case of watching video, wherein the video is displayed only at the external display and the reverse mirroring include only control interface to be displayed on the mobile device.

10. The method of claim 2 wherein the information parameters indicate of user connecting a head set, related uses case of watching video, wherein the video is displayed only at the external display and the reverse mirroring include audio stream.

11. The method of claim 6 wherein streaming quality of control interface is degraded. by degrading the frame rate of the UI elements motion.

12. The method of claim 2 wherein the information parameters relate uses case of games playing session the pre-defined rule determines to decrease the video parameters, while sending all sensor information to the dongle.

13. The method of claim 3 of wherein the information parameters relates to use case of Static applications, identifying when the user view mostly static information, the pre-defined rule determines to decrease the frame rate significantly, while increasing the bit rate.

14. The method of claim 1 further comprising the step of receiving an indication of activation of nearby receiver module before starting the reverse mirroring streaming process.

15. The method of claim 1 further comprising the step of identifying the current status of multimedia activation and wherein the reverse mirroring include streaming the multimedia activated content.

16. A system including at least one processor for real-time multimedia interface management of receiver module associated or integrated with an external display, said receiver device having processor and communication module for supporting streaming multimedia applications, said system comprised of:
a receiver module including Reverse mirroring module for reverse mirroring of activated multimedia applications from the receiver module to a touch enabled device through direct local wireless communication network;
a touch enabled device which and concurrently or non-concurrently convey input data in real-time to the receiver device through direct local wireless communication network and
an interaction module for conveying sensor-related data between the receiver module touch enabled device through direct local wireless communication network, said sensor-related data applied on the touch enabled device or the receiver module according to pre-defined rules and in a way that remotely operates as if the sensor-related data originates in the touch enabled device itself or in the receiver module;
wherein the input data is related to the activation of mirrored multimedia applications.

17. The method of claim 1 wherein the input data include sensor information: all input being received from sensors including at least one of: Touch screen input, Gyroscope movement or Accelerometer input, wherein the receive process the transmitted input data as if the actions detected by the sensors were performed on the receiver itself.

18. The method of claim 1 wherein the interface module apply the following:
Conveying sensor-related data from the receiver module through direct local wireless communication network;
Applying sensor-related data on the touch enabled device according to pre-defined rules and in a way that remotely operates as if the data originates in the touch enabled device itself.

19. The method of claim 1 wherein input data include peripheral information: all input generated by external devices connected to the touch enabled device are transmitted to the receiver and processed by receiver, as if these devices were actually connected to the receiver module.
